(19) United States
(12) Patent Application Publication
(10) Pub. No.: US 2009/0209197 A1
(43) Pub. Date: Aug. 20, 2009

(54) System and method for correlating multi-format, omni-directional communications

(75) Inventors: Mark Andrew Hale, San Jose, CA (US); Richard Edwin Berry, Brisbane, CA (US); Hussam Hamdy Osman, Oakland, CA (US)

Correspondence Address: Dr. Mark Hale;Demandforce, Inc, Suite 600, 425 Second Street, San Francisco, CA, 94107, US

(73) Assignee: Demandforce, Inc., San Francisco, CA (US)

(21) Appl. No.: 12/378,649

(22) Filed: Feb. 17, 2009

Related U.S. Application Data
(60) Provisional application No. 61/064,159, filed on Feb. 20, 2008.

(51) Int. Cl. H04H 20/71

(52) U.S. Cl. 455/3.05

(57) ABSTRACT

This document describes a system and method for correlating multi-format, omni-directional communications. It deploys an intermediary to facilitate message tracking and assignment used to facilitate subsequent message correlation. Secondarily, it deploys a device registration context whereby message correlation can be done. This system possesses the property that it can be deployed in environments whereby no unique message identifier is available to provide directional correlation and that not all messages must flow through the gateway to be correlated.

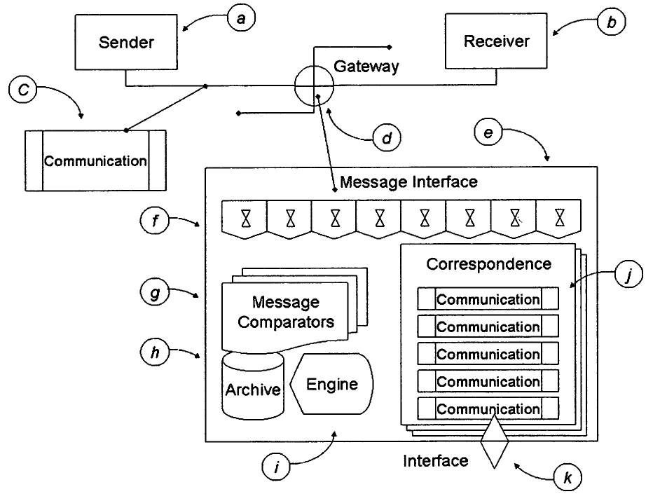

### RELATED APPLICATIONS

1. U.S. Pat. No. 5,959,543, “Two-way wireless messaging system with flexible messaging,” Sep. 28, 1999.

2. U.S. Pat. No. 5,742,668, “Electronic massaging network,” Apr. 21, 1998.

3. U.S. Pat. No. 7,043,262, “A two-way pager for communicating over a Global System for Mobile Communications (GSMGPRS) network,” May 9, 2006.

4. U.S. Pat. No. 5,647,002, “Synchronization of mailboxes of different types,” Jul. 8, 1997.

5. U.S. Pat. No. 5,758,355, “Synchronization of server database with client database using distribution,” May 26, 1998.

6. U.S. Pat. No. 5,842,210, “Method and apparatus for selectively retrieving data from a database,” Nov. 24, 1998.

7. U.S. Pat. No. 6,038,296, “Internet/intranet user interface to a multimedia messaging system,” Mar. 14, 2000

8. U.S. Pat. No. 6,073,165, “Filtering computer network messages directed to a user's e-mail box,” Jun. 6, 2000

9. U.S. Pat. No. 6,182,118, “System and method for distributing electronic messages in accordance with rules,” Jan. 30, 2001

10. U.S. Pat. No. 7,054,626, “Method and architecture for an interactive two-way data communication network,” May 30, 2006

11. U.S. Pat. No. 7,236,769, “Value-added electronic messaging services and transparent implementation,” Jun. 26, 2007

12. Public Law 104-191, Health Insurance Portability and Accountability Act of 1996, Aug. 21, 1996

13. CAN-SPAM Act of 2003, Pub. L. No. 108-187, 117 Stat. 2699 (2003)

### BACKGROUND OF THE INVENTION

1. Field of Invention

Electronic communications are becoming increasingly more widespread with new devices and services becoming routinely available to both consumers and businesses. For example, it is not uncommon for businesses to send out alerts about upcoming appointments via text messages. However, at the same time it is becoming increasingly more difficult to determine a communications trail when users and businesses switch means of communications or the message exchange becomes asynchronous and intractable. An example of which is when a dental office sends a text message to a patient and they choose to reply via a text message on their cell phone. In most cases, the dental practice typically does not maintain a direct relationship with a network carrier and relies on an intermediary. It is therefore important that the invention correlates communications into a communications trail when acting as an intermediary for brokering the business transactions.

2. Brief Description of Background Art

The present invention employs the Wireless Message Protocol v.3.0 as maintained by the Open Mobile Alliance (Apr. 24, 2006).

The present invention employs the MIME specification described by the IETF in the RFC 2045—Multipurpose Internet Mail Extensions (MIME) Part One: Format of Internet Message Bodies (November/1996).

3. Description of the Prior Art

Electronic communications is widespread among consumers and has resulted in the proliferation of handheld devices, including cell phones, personal data assistants, laptops and others. This body of work focuses specifically how businesses maintain a conversation with these consumers through an intermediary.

It is not uncommon for a corporation to send communications directly with a consumer. There are many forms of communication formats such as Email, Text Messaging, Instant Messaging, Regular mail. For instance, in the cases that a company would like to send text messages to their customers, they may obtain access directly from a cell phone carrier (for example Verizon, Sprint, T-Mobile and other carriers) or a broker (such as OpenMarket) to access the carrier network. They then use established techniques described in U.S. Pat. No. 5,959,543 for messaging, U.S. Pat. No. 5,742,668 for the network, and U.S. Pat. No. 7,043,262 for the gateway. Much of this network and ancillary operations are provided by the carriers and access is through a simple WMP gateway.

There are also ways to provide synchronization of actual communications across servers in a variety of formats. U.S. Pat. No. 5,647,002, U.S. Pat. No. 5,758,355, U.S. Pat. No. 5,842,210 and U.S. Pat. No. 6,038,296 describe how access can be obtained to familiar email and database server applications. Others describe the message backbone such as U.S. Pat. No. 7,054,626 and U.S. Pat. No. 7,236,769. Fundamentally, the system of the inventions seeks to span a plurality of communication formats and provide correlation among them.

The correlative component is necessary to order communications into correspondence rather than just synchronize a one-to-one message transaction found in typical communication networks. It is fairly common to filter communications, such as using a spam filter, and these inventions utilize filtering as well U.S. Pat. No. 6,073,165 and U.S. Pat. No. 6,182,118. The invention utilizes these common filtering mechanisms but relies on the new concept of sequencing based on metadata properties found on the network to do that. This will allow for temporal message correlation adding value to businesses.

### SUMMARY OF THE INVENTION

The subject of the invention is to use common forms of communications but to act as an intermediary to the business for the purposes of forming a communications from generally stateless activities. For example, a dentist office could choose to text message their patients via an intermediary would be to provide email, text messaging, instant messaging and other forms of electronic communications. These electronic forms of communication are complimented by offline equivalents such as postcards and letters.

However, most beneficial to dental offices is a communications trail that allows their practice management system to be correlated with a historical record of patient appointments. This would require that any patient communication, regardless of time or format, be correlated into a trail. For example, a patient receives an email or a text message to confirm their appointment on their cell phone. They read it and reply via a text message. The correlation would relate the reply to the appointment of the communications.

A further shortcoming of prior art systems is that they fail to make provisions for the verification of user identify as part of the system. As the number of malicious email traffic, frequently referred to as spam, continues to increase, security risks increase proportionately. This invention accommodates this shortcoming in the method in which the system is implemented. This is important for adhering to emerging compliance standards such as CAN-SPAM and HIPAA.

The system and methods of the invention are significant as businesses seek to achieve the highest level of customer service to their customers, maximize their own revenues and other drives that are communication based. By understanding the communications, businesses can learn what activities lead to increased on-time appointments, promotions increase bookings, and how customer interact for referrals to name a few.

### BRIEF DESCRIPTION OF THE DRAWING

The drawing illustrates the system of the invention. The Sender (a) will send to the Receiver (b) a Communication (c). The Communication passes through a Gateway (d) to arrive there. The system of the invention (e) sits on a gateway and interprets the communications via a Message Interface (f). It uses Message Comparators (g) and its historical data in the Archive (h) in the Engine (i) to correlate the communications into Correspondence (j). The Correspondence is accessed via an Interface (k).

### DETAILED DESCRIPTION OF THE INVENTION

A system and method for correlating multi-format, omni-directional communications into communications is described. In the following description, for illustrative purposes, many specific details pertaining to text messages are set forth in order to provide a thorough understanding of the present invention. It will be apparent, however, to one skilled in the art that the present invention may be applied to other forms of both electronic communications such as email and instant messaging and offline communications such as letters and postcards. Furthermore, the system of the present invention deploys an intermediary to facilitate message tracking and assignment used to facilitate subsequent message correlation. Secondarily, it deploys a device registration context whereby message correlation can be done. This system possesses the property that it can be deployed in environments whereby no unique message identifier is available to provide direction correlation.

The premise of the system of the invention is that entities, individual or businesses, interact with communications in the form of email, text messages, instant messages, letters and so forth from a plurality of possible devices. The system of the invention acts as an intermediary that can initiate or receive electronic communications from the sender as shown in the drawing at (a) or receiver as shown in the drawing at (b). This is done through any number of standard communication protocol or gateways as shown in the drawing at (c). For example, a text message may be received from a user via a dedicated short code. An email may be received through a specified email address defined in an email gateway.

The system and method omni-directional and can both send and receive messages with participants either directly or through a delegate. The system is inserted here as shown in the drawing at (e). A fundamental requirement of the invention is that communications exchanged with a single entity can be correlated and this must allow for both unidirectional and omni-directional messages. Therefore, communications are not only ‘sent’ from an entity to the receiver. The system allows for inbound ‘reply’ messages to be inserted into the communications trail.

A method exists to allow for a plurality of gateways to be employed by the system to allow for the switching of communications format as shown in the drawing at (f). A user may receive an email and then reply with en email, text message, instant message or other electronic communication or print. Furthermore, a method exists to facilitate a plurality of senders and receivers. For example, a person may frequent several businesses. It is necessary to distinguish communications from one entity over another.

Thus, the systems and method of the invention are now able to communicate with all participants, over a variety of gateways and process a plurality of sender and receiver combinations. Now, the system of the invention that addresses correlation processes the messages into a communications trail.

To do so, the system will use the message digest for those messages that have been sent. Communications are considered to start of communications if they do not appear in the digest nor can be correlated against existing communications trail.

These disparate formats are correlated into a single communications trail with an algorithm that checks for the time between communications, the event or activity the communication refers to, historical activities of both sender and receiver and other means to infer the sequence of the communications. This algorithm is called the comparator and is part of the system of the invention. It is processed by the engine in the system as shown in the drawing at (i).

The comparator will work with purely descriptive information by interpreting the contents of the communications. The comparator is shown in the drawing at (g). It works, for example, to examine the time at which is an email is sent and to whom it was sent. It also takes advantage of communication metadata that exist in the intermediaries that are part of the subject of the invention. For example, in addition to knowing who an email was sent to, the comparator also knows that it was sent concerning an appointment that exists in the system by checking historical data as shown in the drawing at (h). Therefore, it may relate these pieces of communications in regards to the appointment at a particular business.

The correlation system will also interpret a plurality of senders and receivers, as shown in the drawing at (d) on the open network, as it processes messages into correspondence by relating the communications as shown in the drawing at (j). For example, if a dentist refers you to an oral specialist, both offices now form a communications unique to the patient visits. Conversely, a plurality of receivers is accommodated as well so that households comprising of more than one individual, customer referrals, and other communications involving more than one participant can be related.

The system of the invention can correlate many disparate communications across a plurality of applications and businesses or individuals into a single communications trail and the finalized correspondence is shown in the drawing at (j). These communications consists of at least one communication and may be organized into an ontology that may be hierarchical, serial or any number of schemes. This business and customers can access the information on this correspondence via an interface as shown in the drawing at (k). Typically this is a web interface but other client applications can be used.

1. A Communications system for correlating communications, comprising:
communications;
a manifest; and
a communications comparator;

2. The Communications system of claim 1, further comprising of a method for providing an omni-directional access to multiple gateways

3. The Communications system of claim 2, further comprising of a method for providing translation through a plurality of gateways

4. The Communications system of claim 1, further comprising of a method accessing a plurality of senders and receivers

5. The Correlation system of claim 1, further comprising of a method for correlating communications using metadata

6. The Correlation system of claim 1, further comprising of a method for correlating omni-directional communications across a plurality of senders and receivers

7. The Correlation system of claim 6, further comprising of a method for sequencing communications

8. The Correlation system of claim 1, further comprising of a method for extracting the correlated communications
